(19) United States
(12) Patent Application Publication
(10) Pub. No.: US 2024/0193725 A1
(43) Pub. Date: Jun. 13, 2024

(54) Optimized Multi View Perspective Approach to Dimension Cuboid Parcel

(71) Applicant: ZEBRA TECHNOLOGIES CORPORATION, Lincolnshire, IL (US)

(72) Inventor: Michael Wijayantha Medagama, Nawala (LK)

(21) Appl. No.: 18/080,675

(22) Filed: Dec. 13, 2022

(51) Int. Cl. G06T 3/40; G06T 5/00; G06T 7/73; G06T 15/40; G06T 17/20

(52) U.S. Cl. CPC G06T 3/4038; G06T 5/002; G06T 7/75; G06T 15/405; G06T 17/205

(57) ABSTRACT

A method and system for performing three dimensional imaging and determining a physical dimension of a target includes capturing, by an imaging system, first and second images of a target with each image obtained at a different perspective of the target. A processor generates first and second point clouds corresponding to the target, from the first and second images. The processor identifies a position and orientation of a reference feature of the target from first and second images, and the processor performs point cloud stitching to combine the first point cloud and the second point cloud to form a merged point cloud. The point cloud stitching is performed according to the orientation and position of the reference feature in each of the first and second point clouds. The processor identifies and removes noisy data points in the merged point cloud to form an aggregated point cloud.

### BACKGROUND

Industrial scanners and/or barcode readers may be used in warehouse environments and/or other environments and may be provided in the form of mobile scanning devices. These scanners may be used to scan barcodes, packages, and other objects. In shipping, and in storage rooms and warehouse settings, scanning of parcels and objects for shipping or storage are essential to properly store and ship objects. Therefore, accurate parcel dimensions are required to ensure proper workflow and to prevent interruptions in services or supply chains. Typical single image capture systems have limitations in determining surface features and dimensions. Additionally, time of flight (TOF) systems often result in incorrect estimates of sizes, locations, and/or orientations of planes, edges, and features of objects. A limiting factor of many typical systems is noisy or artifact 3D points that cause errors in reconstructed or estimated surfaces or object features. Simultaneous localization and mapping algorithms may be used to assist in three-dimensional (3D) mapping, but typical simultaneous localization and mapping (SLAM) algorithms require intensive computer processing which is often limited by resources, and results in very long processing times.

Accordingly, there is a need for improved designs having improved functionalities.

### SUMMARY

In accordance with a first aspect, a method for performing three dimensional imaging includes capturing, by an imaging system, a first image of a target in a first field of view of the imaging system. The imaging system captures a second image of the target in a second field of view of the imaging system, the second field of view being different than the first field of view. A processor generates a first point cloud, corresponding to the target, from the first image, and generates a second point cloud, corresponding to the target, from the second image. The processor identifies a position and orientation of a reference feature of the target in the first image, and further identifies a position and orientation of the reference feature in the second image. The processor performs point cloud stitching to combine the first point cloud and the second point cloud to form a merged point cloud. The point cloud stitching is performed according to the orientation and position of the reference feature in each of the first point cloud and second point cloud. The processor identifies one or more noisy data points in the merged point cloud, and forms an aggregated point cloud, the aggregated point cloud formed by removing at least some of the one or more noisy data points from the merged point cloud and generating an aggregated point cloud from the merged point cloud.

In a variation of the current embodiment, performing point cloud stitching includes the processor (i) identifying a position and orientation of a reference feature of the target in the first image, (ii) identifying a position and orientation of the reference feature in the second image, and (iii) performing the cloud stitching according to the position and orientation of the reference feature in the first and second images. In a variation of the current embodiment, the reference feature may include one or more of a surface, a vertex, a corner, or line edges.

In variations of the current embodiment, the method includes the processor (i) determining a first position of the imaging system from the position and orientation of the reference feature in the first point cloud, (ii) determining a second position of the imaging system from the position and orientation of the reference feature in the second point cloud, and (iii) performing the point cloud stitching further according to the determined first position of the imaging system and second position of the imaging system.

In some variations, the method further includes the processor determining a transformation matrix from the position and orientation of the reference feature in the first point cloud and position and orientation of the reference feature in the second point cloud.

In yet more variations, to identify one or more noisy data point, the method includes the processor (i) determining voxels in the merged point cloud, (ii) determining a number of data points of the merged point cloud in each voxel, (iii) identifying voxels containing a number of data points less than a threshold value, and (iv) identifying the noisy data points as data points in voxels containing equal to or less than the threshold value of data points. In examples, the threshold value is dependent on one or more of an image frame count, image resolution, and voxel size.

In further variations, the method includes the processor performing a three-dimensional construction of the target from the aggregated point cloud, and determining, from the three-dimensional construction, a physical dimension of the target.

In even more variations, the first field of view provides a first perspective of the target, and the second field of view provides a second perspective of the target, the second perspective of the target being different than the first perspective of the target.

In any variations, the imaging system includes one or more of an infrared camera, a color camera, two-dimensional camera, a three-dimensional camera, a handheld camera, or a plurality of cameras.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a block diagram of an example imaging system configured to analyze an image of a target object to execute a machine vision task, in accordance with various embodiments disclosed herein.

FIG. 2 is a side view block diagram of a first embodiment of the imaging device of FIG. 1, in accordance with embodiments described herein.

FIG. 3 is a perspective view of a second embodiment of the imaging device of FIG. 1 that may be implemented in accordance with embodiments described herein.

FIG. 4 is illustrative of an example environment with two imaging devices fixed at two positions relative to a target for obtaining multiple images of the target to perform three dimensional imaging and dimensional reconstruction as described herein.

FIG. 5 is illustrative of an environment with a user using an imaging device to obtain multiple images of the target, with each image obtained at a different perspective of the target to perform three-dimensional reconstruction of one or more features of the target.

FIG. 6 is a flowchart of a method for performing three-dimensional imaging and dimensional reconstruction.

FIG. 7A illustrates a scenario with an imaging device at a first position P1 relative to a target for obtaining images of the target and performing dimensional reconstruction.

FIG. 7B illustrates a scenario with an imaging device at a second position P2 relative to a target for obtaining images of the target and performing dimensional reconstruction.

FIG. 8A is an infrared (IR) image of a target obtained by an imaging device at a first position relative to the target.

FIG. 8B is an image segmentation of a top surface of the target of FIG. 8A.

FIG. 8C is a combined image of the IR image of the target of FIG. 8A overlayed with the top plane segmentation of FIG. 8B.

FIG. 9A is an IR image of a target obtained by an imaging device at a first position relative to the target.

FIG. 9B is an image segmentation of a top surface of the target of FIG. 9A.

FIG. 9C is a combined image of the IR image of the target of FIG. 9A overlayed with the top plane segmentation of FIG. 9B.

FIG. 10A is an IR image of a target obtained by an imaging device at a first position relative to the target.

FIG. 10B is an image segmentation of a top surface of the target of FIG. 10A.

FIG. 10C is a combined image of the IR image of the target of FIG. 10A overlayed with the top plane segmentation of FIG. 10B.

FIG. 11A is an IR image of a target obtained by an imaging device at a first position relative to the target.

FIG. 11B is an image segmentation of a top surface of the target of FIG. 11A.

FIG. 11C is a combined image of the IR image of the target of FIG. 11A overlayed with the top plane segmentation of FIG. 11B.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally, pursuant to these various embodiments, a compact portable object scanner is provided that may capture images of an object for performing multi-view reconstruction of a target. In examples, the target may be a parcel such as a box. For the methods and systems described herein, the target will be referred to as a cuboid having a volume defined by a height, width, and length. The described method obtains two or more images of the target, with each image capture at a different perspective of the target. The images may be captured by a single camera that is moved to different perspectives, capturing images at different fields of view of the target, or the images may be captured by a plurality of cameras with each camera having a corresponding field of view, with each field of view having a respective perspective of the target. Three-dimensional (3D) point clouds are then determined from the two or more images of the target, and a noise removal process is performed before dimensional reconstruction of one or more features of the target is performed. The dimensional reconstruction may be used to determine a volume of the target and/or the size of one or more features of the target (e.g., length, width, or height, one or more aspect ratios of any dimensions of the target, location of one or more surfaces, one or more surfaces areas, spatial location of a vertex, etc.). The dimensional analysis may then be stored in a memory or provided to other systems for properly storing the target in a warehouse or other environment, or for determining shipping logistics of the target (e.g., determine a proper orientation of the target in a shipping container to maximize the efficiency of volume in a shipping container, determine required size of a shipping container, etc.).

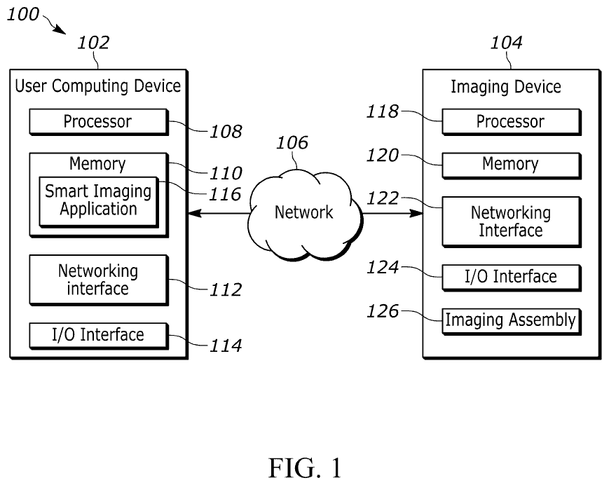

FIG. 1 illustrates an example imaging system 100 configured to analyze an image of a target object to execute a machine vision task, in accordance with various embodiments disclosed herein. Machine vision may also be referred to as computer vision for the systems and methods described herein. The imaging system 100 is configured to detect 3D physical features of targets, reduce noise in the 3D data, and provide reconstruction of dimensions and physical features of the targets. In the example embodiment of FIG. 1, the imaging system 100 includes a user computing device 102 and an imaging device 104 communicatively coupled via a network 106. The user computing device 102 may include one or more processors 108, one or more memories 110, a networking interface 112, an input/output (I/O) interface 114, and a smart imaging application 116. The user computing device 102 and the imaging device 104 may be capable of executing instructions to, for example, implement operations of the example methods described herein, as may be represented by the flowcharts of the drawings that accompany this description. The user computing device 102 is generally configured to enable a user/operator to create a machine vision task for execution on the imaging device 104. In examples, the imaging device 104 may utilize machine vision techniques to analyze captured images and execute a task. In other examples, the imaging device 104 may capture images and provide the images to another device such as a network, or processor, that may analyze the images and perform a machine vision task for image processing. When created, the user/operator may then transmit/upload the machine vision task to the imaging device 104 via the network 106, where the machine vision task is then interpreted and executed.

The imaging device 104 is connected to the user computing device 102 via a network 106, and is configured to interpret and execute tasks received from the user computing device 102. Generally, the imaging device 104 may obtain a task file containing one or more task scripts from the user computing device 102 across the network 106 that may define the machine vision task and may configure the imaging device 104 to capture and/or analyze images in accordance with the task. For example, the imaging device 104 may include flash memory used for determining, storing, or otherwise processing imaging data/datasets and/or post-imaging data. The imaging device 104 may then receive, recognize, and/or otherwise interpret a trigger that causes the imaging device 104 to capture an image of the target object in accordance with the configuration established via the one or more task scripts. Once captured and/or analyzed, the imaging device 104 may transmit the images and any associated data across the network 106 to the user computing device 102 for further analysis and/or storage. In various embodiments, the imaging device 104 may be a “smart” camera and/or may otherwise be configured to automatically obtain, interpret, and execute task scripts that define machine vision tasks, such as any one or more task scripts contained in one or more task files as obtained, for example, from the user computing device 102. In examples, the imaging device 104 may be a handheld device that a user controls to capture one or more images of a target at one or more perspectives of the target for further processing of the images and for reconstruction of one or more features or dimensions of the target.

Broadly, the task file may be a JSON representation/data format of the one or more task scripts transferrable from the user computing device 102 to the imaging device 104. The task file may further be loadable/readable by a C++ runtime engine, or other suitable runtime engine, executing on the imaging device 104. Moreover, the imaging device 104 may run a server (not shown) configured to receive task files across the network 106 from the user computing device 102. Additionally or alternatively, the server configured to receive task files may be implemented as one or more cloud-based servers, such as a cloud-based computing platform. For example, the server may be any one or more cloud-based platform(s) such as MICROSOFT AZURE, AMAZON AWS, or the like.

The imaging device 104 may include one or more processors 118, one or more memories 120, a networking interface 122, an I/O interface 124, and an imaging assembly 126. The imaging assembly 126 may include a digital camera and/or digital video camera for capturing or taking digital images and/or frames. Each digital image may comprise pixel data, voxel data, vector information, or other image data that may be analyzed by one or more tools each configured to perform an image analysis task. The digital camera and/or digital video camera of, e.g., the imaging assembly 126 may be configured, as disclosed herein, to take, capture, obtain, or otherwise generate digital images and, at least in some embodiments, may store such images in a memory (e.g., one or more memories 110, 120) of a respective device (e.g., user computing device 102, imaging device 104).

For example, the imaging assembly 126 may include a photo-realistic camera (not shown) for capturing, sensing, or scanning two-dimensional (2D) image data. The photo-realistic camera may be a red, green blue (RGB) based camera for capturing 2D images having RGB-based pixel data. In various embodiments, the imaging assembly may additionally include a 3D camera (not shown) for capturing, sensing, or scanning 3D image data. The 3D camera may include an Infra-Red (IR) projector and a related IR camera for capturing, sensing, or scanning 3D image data/datasets. In some embodiments, the photo-realistic camera of the imaging assembly 126 may capture 2D images, and related 2D image data, at the same or similar point in time as the 3D camera of the imaging assembly 126 such that the imaging device 104 can have both sets of 3D image data and 2D image data available for a particular surface, object, area, or scene at the same or similar instance in time. In various embodiments, the imaging assembly 126 may include the 3D camera and the photo-realistic camera as a single imaging apparatus configured to capture 3D depth image data simultaneously with 2D image data. As such, the captured 2D images and the corresponding 2D image data may be depth-aligned with the 3D images and 3D image data.

In embodiments, the imaging assembly 126 may be configured to capture images of surfaces or areas of a predefined search space or target objects within the predefined search space. For example, each tool included in a task script may additionally include a region of interest (ROI) corresponding to a specific region or a target object imaged by the imaging assembly 126. The ROI may be a predefined ROI, or the ROI may be determined through analysis of the image by the processor 118. Further, a plurality of ROIs may be predefined or determined through image processing. The composite area defined by the ROIs for all tools included in a particular task script may thereby define the predefined search space which the imaging assembly 126 may capture to facilitate the execution of the task script. However, the predefined search space may be user-specified to include a field of view (FOV) featuring more or less than the composite area defined by the ROIs of all tools included in the particular task script. The imaging assembly 126 may be configured to identify predefined objects or physical features for reconstruction of a target or dimensions of a target. For example, the imaging assembly 126 may be configured to identify a cuboid, or features of a cuboid (e.g., vertices, edge lines, surfaces, etc.) of a box or parcel for further processing to determine a size or other dimension of one or more features of the cuboid.

It should be noted that the imaging assembly 126 may capture 2D and/or 3D image data/datasets of a variety of areas, such that additional areas in addition to the predefined search spaces are contemplated herein. Moreover, in various embodiments, the imaging assembly 126 may be configured to capture other sets of image data in addition to the 2D/3D image data, such as grayscale image data or amplitude image data, each of which may be depth-aligned with the 2D/3D image data. Further, one or more ROIs may be within a FOV of the imaging system such that any region of the FOV of the imaging system may be a ROI.

The imaging device 104 may also process the 2D image data/datasets and/or 3D image datasets for use by other devices (e.g., the user computing device 102, an external server). For example, the one or more processors 118 may process the image data or datasets captured, scanned, or sensed by the imaging assembly 126. The processing of the image data may generate post-imaging data that may include metadata, simplified data, normalized data, result data, status data, or alert data as determined from the original scanned or sensed image data. The image data and/or the post-imaging data may be sent to the user computing device 102 executing the smart imaging application 116 for viewing, processing, and/or otherwise interaction. In other embodiments, the image data and/or the post-imaging data may be sent to a server for storage or for further manipulation. As described herein, the user computing device 102, imaging device 104, and/or external server or other centralized processing unit and/or storage may store such data, and may also send the image data and/or the post-imaging data to another application implemented on a user device, such as a mobile device, a tablet, a handheld device, or a desktop device.

Each of the one or more memories 110, 120 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. In general, a computer program or computer based product, application, or code (e.g., smart imaging application 116, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the one or more processors 108, 118 (e.g., working in connection with the respective operating system in the one or more memories 110, 120) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

The one or more memories 110, 120 may store an operating system (OS) (e.g., Microsoft Windows, Linux, Unix, etc.) capable of facilitating the functionalities, apps, methods, or other software as discussed herein. The one or more memories 110 may also store the smart imaging application 116, which may be configured to enable machine vision task construction, as described further herein. Additionally, or alternatively, the smart imaging application 116 may also be stored in the one or more memories 120 of the imaging device 104, and/or in an external database (not shown), which is accessible or otherwise communicatively coupled to the user computing device 102 via the network 106. The one or more memories 110, 120 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, or APIs may be, include, otherwise be part of, a machine vision based imaging application, such as the smart imaging application 116, where each may be configured to facilitate their various functionalities discussed herein. It should be appreciated that one or more other applications may be envisioned and may be executed by the one or more processors 108, 118.

The one or more processors 108, 118 may be connected to the one or more memories 110, 120 via a computer bus responsible for transmitting electronic data, data packets, or otherwise electronic signals to and from the one or more processors 108, 118 and one or more memories 110, 120 to implement or perform the machine readable instructions, methods, processes, elements or limitations, as illustrated, depicted, or described for the various flowcharts, illustrations, diagrams, figures, and/or other disclosure herein.

The one or more processors 108, 118 may interface with the one or more memories 110, 120 via the computer bus to execute the operating system (OS). The one or more processors 108, 118 may also interface with the one or more memories 110, 120 via the computer bus to create, read, update, delete, or otherwise access or interact with the data stored in the one or more memories 110, 120 and/or external databases (e.g., a relational database, such as Oracle, DB2, MySQL, or a NoSQL based database, such as MongoDB). The data stored in the one or more memories 110, 120 and/or an external database may include all or part of any of the data or information described herein, including, for example, machine vision task images (e.g., images captured by the imaging device 104 in response to execution of a task script) and/or other suitable information.

The networking interfaces 112, 122 may be configured to communicate (e.g., send and receive) data via one or more external/network port(s) to one or more networks or local terminals, such as network 106, described herein. In some embodiments, networking interfaces 112, 122 may include a client-server platform technology such as ASP.NET, Java J2EE, Ruby on Rails, Node.js, a web service or online API, responsive for receiving and responding to electronic requests. The networking interfaces 112, 122 may implement the client-server platform technology that may interact, via the computer bus, with the one or more memories 110, 120 (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

According to some embodiments, the networking interfaces 112, 122 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to network 106. In some embodiments, network 106 may comprise a private network or local area network (LAN). Additionally or alternatively, network 106 may comprise a public network such as the Internet. In some embodiments, the network 106 may comprise routers, wireless switches, or other such wireless connection points communicating to the user computing device 102 (via the networking interface 112) and the imaging device 104 (via networking interface 122) via wireless communications based on any one or more of various wireless standards, including by non-limiting example, IEEE 802.11a/b/c/g (WIFI), the BLUETOOTH standard, or the like.

The I/O interfaces 114, 124 may include or implement operator interfaces configured to present information to an administrator or operator and/or receive inputs from the administrator or operator. An operator interface may provide a display screen (e.g., via the user computing device 102 and/or imaging device 104) which a user/operator may use to visualize any images, graphics, text, data, features, pixels, and/or other suitable visualizations or information. For example, the user computing device 102 and/or imaging device 104 may comprise, implement, have access to, render, or otherwise expose, at least in part, a graphical user interface (GUI) for displaying images, graphics, text, data, features, pixels, and/or other suitable visualizations or information on the display screen. The I/O interfaces 114, 124 may also include I/O components (e.g., ports, capacitive or resistive touch sensitive input panels, keys, buttons, lights, LEDs, any number of keyboards, mice, USB drives, optical drives, screens, touchscreens, etc.), which may be directly/indirectly accessible via or attached to the user computing device 102 and/or the imaging device 104. According to some embodiments, an administrator or user/operator may access the user computing device 102 and/or imaging device 104 to construct tasks, review images or other information, make changes, input responses and/or selections, and/or perform other functions.

As described above herein, in some embodiments, the user computing device 102 may perform the functionalities as discussed herein as part of a “cloud” network or may otherwise communicate with other hardware or software components within the cloud to send, retrieve, or otherwise analyze data or information described herein.

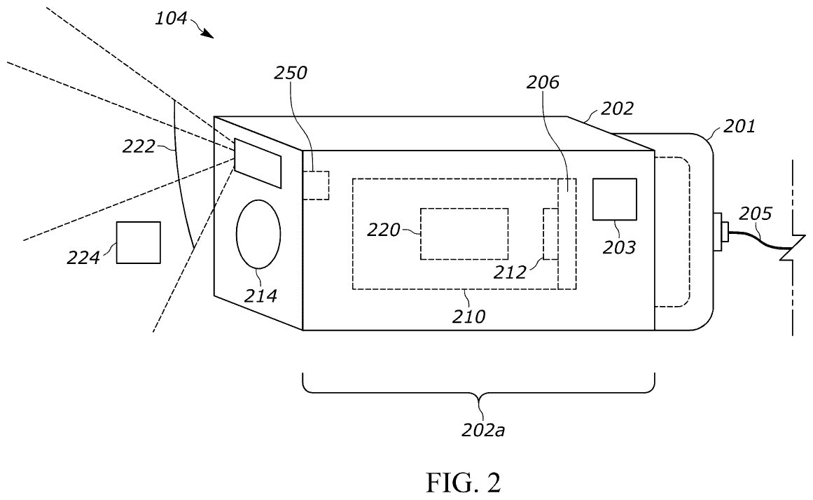

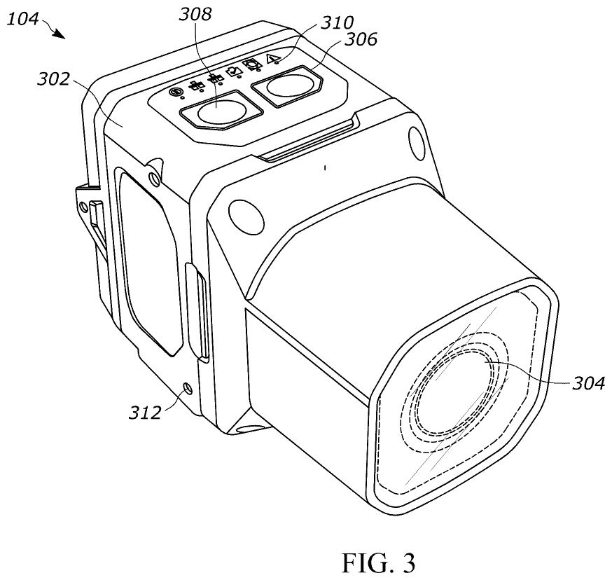

Two embodiments of imaging devices for performing multi-view dimensional reconstruction of a cuboid parcel, as described herein, are shown in schematics in FIGS. 2-3. Referring now to FIG. 2, the imaging device 104 includes a housing 202, an illumination system 250, and an imaging system 210 at least partially disposed within the housing 202 that includes an imaging camera assembly. Specifically, the imaging system 210 includes an image sensor 212 and a lens assembly 220. The device 104 may be adapted to be inserted into a docking station 201 which, in some examples, may include an AC power source 205 to provide power for the device 104. The device 104 may further include an onboard power supply 203, such as a battery and a printed circuit board 206 that may accommodate a memory and a controller that controls operation of the imaging system 210. In embodiments, the device 104 may include a trigger (not shown in the illustration) that is used to activate the imaging system 210 to capture an image. The device 104 may include any number of additional components such as decoding systems, processors, and/or circuitry coupled to the circuit board 206 to assist in operation of the device 104.

The housing 202 includes a forward or reading head portion 202a which supports the imaging system 210 within an interior region of the housing 202. The imaging system 210 may, but does not have to be, modular as it may be removed or inserted as a unit into the devices, allowing the ready substitution of illumination systems 250 and/or imaging systems 210 having different illumination and/or imaging characteristics (e.g., illumination systems having different illumination sources, lenses, illumination filters, illumination FOVs and ranges of FOVs, camera assemblies having different focal distances, working ranges, and imaging FOVs) for use in different devices and systems. In some examples, the field of view may be static.

The image sensor 212 may have a plurality of photosensitive elements forming a substantially flat surface and may be fixedly mounted relative to the housing 202 using any number of components and/or approaches. The image sensor 212 further has a defined central imaging axis, A, that is normal to the substantially flat surface. In some embodiments, the imaging axis A is coaxial with a central axis of the lens assembly 220. The lens assembly 220 may also be fixedly mounted relative to the housing 202 using any number of components and/or approaches. In the illustrated embodiment, the lens assembly 220 is positioned between a front aperture 214 and the image sensor 212. The front aperture 214 blocks light from objects outside of the field of view which reduces imaging problems due to stray light from objects other than the target object. Additionally, the front aperture 214 in conjunction with a one or more lenses allows for the image to form correctly on the imaging sensor 212.

The housing 202 includes an illumination system 250 configured to illuminate a target object of interest for imaging of the target. The target may be a 1D barcode, 2D barcode, QR code, Universal Product Code (UPC) code, or another indicia indicative of the object of interest such as alphanumeric characters or other indicia. Additionally, the target may include one or more boxes, vehicles, rooms, containers, or cuboid parcels, and the imaging system 250 may be configured to capture a color image or infrared image of the one or more targets. The illumination system 250 may provide illumination to an illumination FOV 222 to enable or assist with imaging a target 224.

FIG. 3 is a perspective view of a second embodiment of an imaging device 104 that may be implemented in accordance with embodiments described herein. The imaging device 104 includes a housing 302, an imaging aperture 304, a user interface label 306, a dome switch/button 308, one or more light emitting diodes (LEDs) 310, and mounting point(s) 312. As previously mentioned, the imaging device 104 may obtain task files from a user computing device (e.g., user computing device 102) which the imaging device 104 thereafter interprets and executes. The instructions included in the task file may include device configuration settings (also referenced herein as “imaging settings”) operable to adjust the configuration of the imaging device 104 prior to capturing images of a target object.

For example, the device configuration settings may include instructions to adjust one or more settings related to the imaging aperture 304. As an example, assume that at least a portion of the intended analysis corresponding to a machine vision task requires the imaging device 104 to maximize the brightness of any captured image. To accommodate this requirement, the task file may include device configuration settings to increase the aperture size of the imaging aperture 304. The imaging device 104 may interpret these instructions (e.g., via one or more processors 118) and accordingly increase the aperture size of the imaging aperture 304. Thus, the imaging device 104 may be configured to automatically adjust its own configuration to optimally conform to a particular machine vision task. Additionally, the imaging device 104 may include or otherwise be adaptable to include, for example but without limitation, one or more bandpass filters, one or more polarizers, one or more waveplates, one or more DPM diffusers, one or more C-mount lenses, and/or one or more C-mount liquid lenses over or otherwise influencing the received illumination through the imaging aperture 304.

The user interface label 306 may include the dome switch/button 308 and one or more LEDs 310, and may thereby enable a variety of interactive and/or indicative features. Generally, the user interface label 306 may enable a user to trigger and/or tune the imaging device 104 (e.g., via the dome switch/button 308) and to recognize when one or more functions, errors, and/or other actions have been performed or taken place with respect to the imaging device 104 (e.g., via the one or more LEDs 310). For example, the trigger function of a dome switch/button (e.g., dome/switch button 308) may enable a user to capture an image using the imaging device 104 and/or to display a trigger configuration screen of a user application (e.g., smart imaging application 116). The trigger configuration screen may allow the user to configure one or more triggers for the imaging device 104 that may be stored in memory (e.g., one or more memories 110, 120) for use in later developed machine vision tasks, as discussed herein. The imaging device 104 may be a portable imaging device that a user may move around a target to obtain images at different perspectives of the target. The different perspectives may be considered to be taken at different fields of view of the imaging device 104. The imaging device 104 may have a single field of view but the perspective of the target may change based on the position and orientation of the imaging device 104 and corresponding field of view. In examples, a system may employ an imaging device having multiple fields of view with each field of view having a different spatial perspective of a target. As such, the imaging device may obtain multiple images of the target at different perspectives corresponding to the different fields of view of the imaging device. In more examples, a system may employ multiple imaging devices 104 with each imaging device 104 having a respective field of view with each field of view having a different perspective of a target. Therefore, each of the imaging devices may obtain an image at a different perspective for performing the methods described herein.

As another example, the tuning function of a dome switch/button (e.g., dome/switch button 308) may enable a user to automatically and/or manually adjust the configuration of the imaging device 104 in accordance with a preferred/predetermined configuration and/or to display an imaging configuration screen of a user application (e.g., smart imaging application 116). The imaging configuration screen may allow the user to configure one or more configurations of the imaging device 104 (e.g., aperture size, exposure length, etc.) that may be stored in memory (e.g., one or more memories 110, 120) for use in later developed machine vision tasks, as discussed herein.

To further this example, and as discussed further herein, a user may utilize the imaging configuration screen (or more generally, the smart imaging application 116) to establish two or more configurations of imaging settings for the imaging device 104. The user may then save these two or more configurations of imaging settings as part of a machine vision task that is then transmitted to the imaging device 104 in a task file containing one or more task scripts. The one or more task scripts may then instruct the imaging device 104 processors (e.g., one or more processors 118) to automatically and sequentially adjust the imaging settings of the imaging device 104 in accordance with one or more of the two or more configurations of imaging settings after each successive image capture.

The mounting point(s) 312 may enable a user connecting and/or removably affixing the imaging device 104 to a mounting device (e.g., imaging tripod, camera mount, etc.), a structural surface (e.g., a warehouse wall, a warehouse ceiling, scanning bed or table, structural support beam, etc.), other accessory items, and/or any other suitable connecting devices, structures, or surfaces. For example, the imaging device 104 may be optimally placed on a mounting device in a distribution center, manufacturing plant, warehouse, and/or other facility to image and thereby monitor the quality/consistency of products, packages, and/or other items as they pass through the imaging device's 104 FOV. Moreover, the mounting point(s) 312 may enable a user to connect the imaging device 104 to a myriad of accessory items including, but without limitation, one or more external illumination devices, one or more mounting devices/brackets, and the like.

In addition, the imaging device 104 may include several hardware components contained within the housing 302 that enable connectivity to a computer network (e.g., network 106). For example, the imaging device 104 may include a networking interface (e.g., networking interface 122) that enables the imaging device 104 to connect to a network, such as a Gigabit Ethernet connection and/or a Dual Gigabit Ethernet connection. Further, the imaging device 104 may include transceivers and/or other communication components as part of the networking interface to communicate with other devices (e.g., the user computing device 102) via, for example, Ethernet/IP, PROFINET, Modbus TCP, CC-Link, USB 3.0, RS-232, and/or any other suitable communication protocol or combinations thereof.

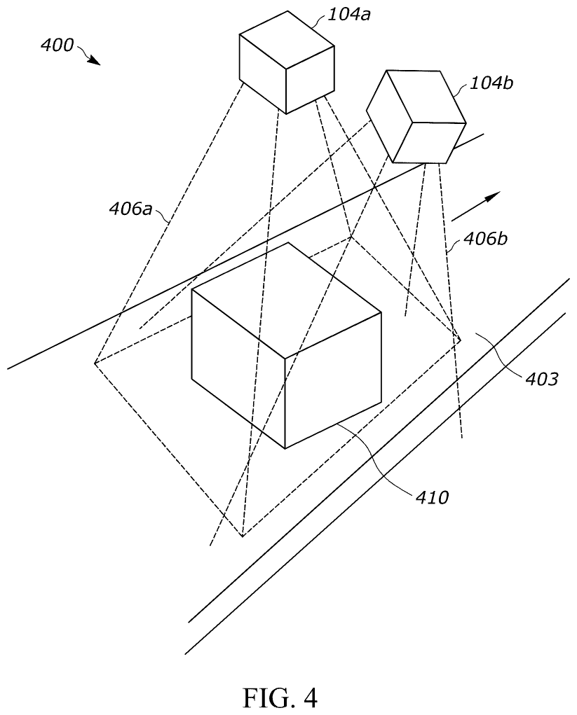

FIG. 4 is illustrative of an example environment 400 with two imaging devices 104a and 104b fixed at two positions relative to a target 410, for obtaining multiple images of the target 410 to perform three dimensional imaging and dimensional reconstruction as described herein. In the environment 400 of FIG. 4 the imaging devices 104a and 104b are positioned above at different relative angles from the target 410. In implementation, the imaging devices may include one or more of the devices 104 illustrated in FIGS. 2 and 3, or may be another imaging device. As FIG. 4 illustrates, the target 410 may be disposed on a scanning surface 403 and the imaging devices 104a and 104b may be disposed and oriented such that fields of view (FOVs) 406a and 406b of the imaging devices 104a and 104b include a portion of the scanning surface 403. The scanning surface 403 may be a table, podium, mount for mounting an object or part, a conveyer, a cubby hole, or another mount or surface that may support a part or object to be scanned. As illustrated, the scanning surface 403 is a conveyer belt having an object of interest 410 thereon. The object of interest 410 is illustrated as being within the FOVs 406a and 406b of the imaging devices 104a and 104b. Each of the imaging devices 104a and 104b captures one or more images of the object of interest 410 and identifies one or more physical features of the object of interest. For example, the imaging devices 104a and 104b, or a system in communication with the imaging devices 104a and 104b, may determine a vertex, edge line, planar features such as top or side of the object of interest 410, a height, width, depth, or another physical feature of the object of interest 410. As illustrated, the object of interest 410 is a cuboid parcel, while in other implementations the object of interest 410 may include other three-dimensional geometric shapes and features such as a hyperrectangle, pyramid, sphere, prism, cylinder, cone, tube, a polyhedral, or another three-dimensional structure.

In examples, each of the imaging devices 104a and 104b captures one or more images at different physical perspectives, with each of the imaging devices 104a and 104b having different FOVs of the object of interest 410. The imaging devices 104a and 104b may be mounted above or around the object of interest 410 on a ceiling, a beam, a metal tripod, or another object for supporting the position of the imaging devices 104a and 104b for capturing images of the scanning bed 403 and objects disposed thereon. Further, the imaging devices 104a and 104b may alternatively be mounted on a wall or another mount that faces objects on the scanning bed 403 from a horizontal direction. In examples, the imaging devices 104a and 104b may be mounted on any apparatus or surface for imaging and scanning objects of interest that are in, or pass through, the FOVs 406a and 406b of the imaging devices 104a and 104b.

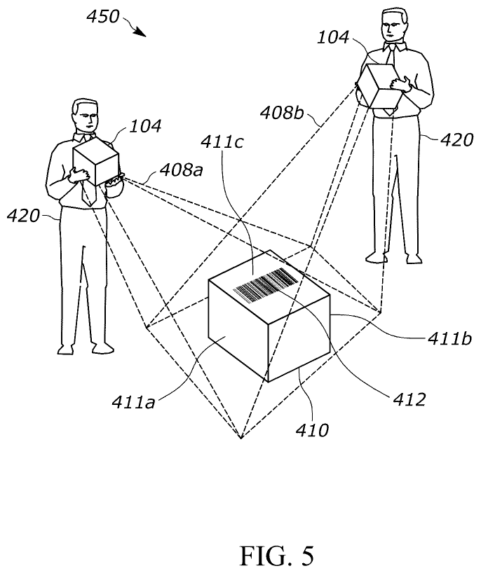

FIG. 5 is illustrative of a scenario environment 450 with a user 420 using an imaging device 104 to obtain multiple images of the target 410, with each image obtained at a different perspective of the target 410. In contrast to the environment 400 of FIG. 4, the example of FIG. 5 implements only a single imaging device 104 to capture multiple images of the target 410. A user 420 may position themselves at various positions to obtain multiple images having different physical perspectives of the target 410. The various images will include some same physical features such as a same vertex, or a same planar top of the target, while the images include other features not visible from other perspectives such as various planar side walls of the cuboid parcel target 410.

In an example, the user 420 positions themselves at a first position having a first FOV perspective 408a of the target 410. The first FOV perspective 408a may provide an image of the target 410 that includes a top planar surface 411c of the target 410 and a first side planar wall 411a of the target 410. The user 420 may then move to a second position and obtain an image of the target 410 at a second FOV perspective 408b of the target 410. The second FOV perspective 408b may provide images that include the top planar surface 411c, and a second planar side wall 411b of the target 410. The first planar side wall 411a may not be visible from the second FOV perspective 408b, and the second planar side wall 411b may not be visible from the first FOV perspective 408a. As such, each of the obtained images may include overlapping physical features of the target 410 (e.g., the top planar surface 411c), while also including different features not imaged at the other FOV perspectives (e.g., each of the planar side walls 411a and 411b). The described methods may then be performed to reconstruct the target 410 using the multiple images of the target 410, and/or reconstruct physical features of the target 410. While described herein as obtaining two images at two different perspectives, the methods described may reconstruct a target or physical features of a target using more than two images. For example, the user 420 may move to a third position and obtain an image having a different perspective than either of the first or second FOV perspectives 408a and 408b. In some examples, with targets having more complex geometries, using more images of the target may provide for more accurate three-dimensional reconstruction of the target and/or physical features thereof.

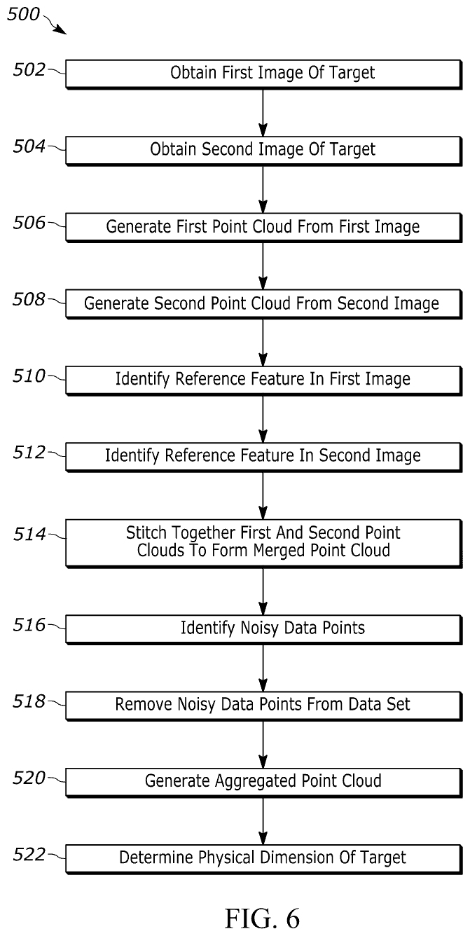

FIG. 6 is a flowchart of a method 500 for performing three-dimensional imaging and dimensional reconstruction. The method 500 includes capturing a first image of a target at 502. The first image may be captured by an imaging system including an imaging device such as the imaging devices 104 of FIGS. 2 and 3, or by another camera or imaging device or system. The imaging device captures an image of a FOV of the imaging device 104, the target being disposed in the FOV of the imaging device. In examples, the imaging system may include one or more of an infrared camera, a color camera, two-dimensional camera, a three-dimensional camera, a handheld camera, or a plurality of cameras.

The imaging system captures a second image of the target at 504. The second image is captured at a second FOV of the imaging system. As previously discussed, the first image may be obtained using a first imaging device having a first FOV, and the second image may be obtained using a second imaging device having a second FOV that is different than the first FOV. In examples, the first and second images may be obtained using a single imaging device, with the imaging device being at different positions while obtaining the first and second images resulting in the first image providing a first perspective of the target and the second image providing a second, different, perspective of the target. As such, the first and second images are obtained at different FOVs or physical perspectives of the target.

The method further includes a processor, such as the processor 118 of the imaging device 104 of FIG. 1, or the processor 108 of the computing device 102, generating a first point cloud from the first image at 506. The first point cloud is a three-dimensional point cloud that is representative of three-dimensional information pertaining to the target, and may include additional points indicative of the environment surrounding the target (e.g., a conveyer belt, table top, floor, room, etc.). The processor may determine a region of interest in the image that includes the target, and the processor then generates a first point cloud corresponding to the target in the first image.

The processor determines a second point cloud corresponding to the target from the second image at 508. While both the first and second point clouds correspond to the target, they provide three-dimensional point cloud representations of the target at different perspectives of the target. The first and second point clouds may contain some common three-dimensional features such as vertices, line edges, or planar sides of the target, as previously described.

The processor then identifies a position and orientation of a reference feature in the first image at 510. The reference feature is a physical feature of the target which may include a surface, a vertex, a corner, and one or more line edges. The processor then identifies the reference feature in the second image at 512. Once the same reference feature has been identified in both the first and second images, the relative orientations and positions of the target may be determined for the first and second images. For example, the reference feature may be a vertex of a cuboid parcel, and it may be determined that the perspective of the cuboid parcel in the second image is rotated by 90° around the parcel compared to the perspective of the first image. In examples, the position and orientation of the imaging device, relative to the target, may be determined from the position and orientation of the reference feature in the first and second images. Then, the relative position and orientation of the imaging device may be determined for the first image and second image, and respective perspectives of the target in the first image and second image may be determined.

In examples, a top surface of a cuboid parcel may be identified in an image, and a floor surface that the parcel is disposed on may also be determined in the image. The top surface and floor may then be used to construct a coordinate system for determining a position and orientation of the imaging device. The same top surface, and determined coordinate system, may then be used across multiple images to determine the position and orientation of the imaging device from different respective perspectives.

After the reference feature has been identified in the first and second images, the processor identifies the reference feature in the first and second point clouds and the processor performs stitching of the first and second point clouds and generates a merged point cloud at 514. The point cloud stitching is performed according to the determined position and orientation of the reference feature in each of the images, and/or each of the corresponding point clouds. In examples, the processor may identify the reference feature in the first and second point clouds without identifying the reference feature in the first and second images. As such, the processor may reduce processing time and resources and generate the merged point cloud based solely on the identified position and orientation of the reference feature in the first and second point clouds. The processor may perform Z-buffering on the first point cloud, second point cloud, and/or merged point cloud to remove data points that are spatially outside of the first FOV or perspective, or the second FOV or perspective, of the imaging system, or an imaging device thereof.

To perform the point cloud stitching the method 500 may further include the processor determining a first position of the imaging system relative to the target. In examples, such as the environment 350 illustrated in FIG. 5, the processor may determine the first position of the imaging system from the position and orientation of the reference feature in the first point cloud and/or first image. The processor may then determine a second position of the imaging system from the position and orientation of the reference feature in the second point cloud and/or second image. The processor then performs the point cloud stitching according to the determined first position of the imaging system and second position of the imaging system.

In some implementations, the processor may determine a transformation matrix for performing the point cloud stitching. The processor may determine the transformation matrix from the positions and orientations of the reference feature in the first and second images. The transformation matrix may be indicative of a spatial transformation of the position and orientation of the reference feature from the first image into the position and orientation of the reference feature in the second image. Similarly, the processor may determine the transformation matrix from the first and second point clouds and the transformation matrix may be indicative of a transformation of the position and orientation of the reference feature from the first point cloud to the position and orientation of the reference feature in the second point cloud. Additionally, the transformation matrix may transform the position of the reference feature from the second image to the position and orientation of the reference feature in the first image, and/or from the position and orientation of the reference feature in the second point cloud to the position and orientation of the reference feature in the first point cloud. Additionally, the processor may determine the transformation matrix from determined first and second positions of the imaging system. In some examples, the transformation matrix may be known or predetermined. For example, in the environment illustrated by FIG. 4 the positions of the imaging devices 104 is static and a static transformation matrix may be determined from the relative positions of the imaging devices 104. In any implementation, the point cloud stitching may be performed according to a determined, or predetermined transformation matrix.

The method 500 further includes the processor identifying noisy data points in the merged point cloud at 516. A “noisy data point” may include a three-dimensional data point that has an incorrect depth value due to a given perspective or signal-to-noise ratio (SNR) of the imaging device. Noisy data points may also be due to a given perspective that includes one or more background objects in the captured image. The noisy data points may be multipath artifacts due to the different objects in the images of the different respective perspectives which is typical in time-of-flight 3D point clouds. The processor may identify one or more noisy data points in the merged point cloud through a voxel population method. For example, the processor may determine or identify voxels in the merged point cloud, and the processor may determine the number of data points in each voxel. The processor may identify voxels having a reduced number of voxels and may determine that the data points in the voxels having too few data points are noisy data points. For example, for an implementation using two point clouds of a target, the merged point cloud should include two point clouds in voxels that are shared in the perspectives of the first and second images (e.g., one data point from the first point cloud, and a second data point from the second point cloud). If it is determined that a shared voxel between the perspectives of the two point clouds only contains one data point, it may be determined that that data point is a noisy data point. In examples, noisy data points may be determined as data points in voxels containing a number of data points below a threshold value. In implementations that use six images of the target, it may be determined that voxels having less than four data points contain noise data points. Another number of data points may be used as the threshold value depending on the specific imaging system, imaging device, target, image resolution, voxel size, image frame count, and number of obtained images.

The processor removes the noisy data points from the merged cloud at 518. The processor may remove all of the determined noisy data points, or a subset of the noisy data points. In implementations, the processor removes at least some of the data points from the merged point cloud. The processor then generates an aggregated point cloud from the merged point cloud, the aggregated point cloud having all or some of the noisy points removed from the data set at 520. The processor performs a three-dimensional reconstruction of the target from the aggregated point cloud at 522. The processor may then determine one or more physical dimensions, or physical features of the target from the three-dimensional reconstruction. For example, the processor may determine the width, length, and/or depth of a surface of the target, the angle of two edges at a vertex of the target, the distance between vertices of the target, the surface area of a surface, a depth, width, or length of the target, or another physical dimension or feature of the target.

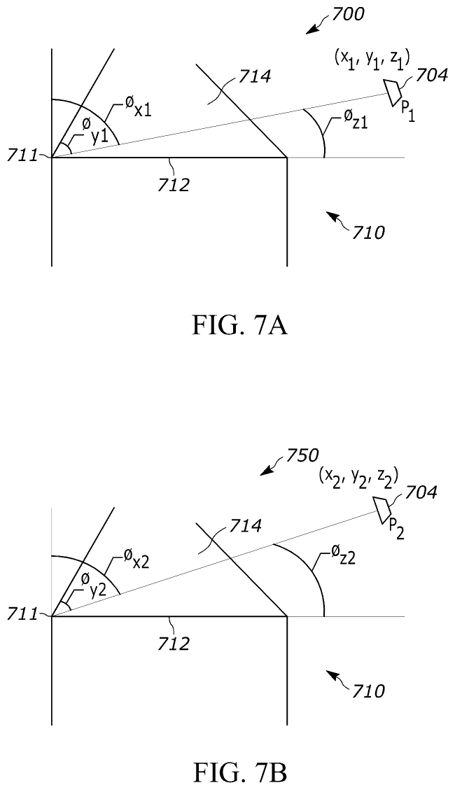

FIG. 7A illustrates a scenario 700 with an imaging device 704 at a first position P1 relative to a target 710. The target has a front edge 712 and a top surface 714 that are both in the FOV of the imaging device 704. FIG. 7B illustrates a similar scenario 750 with the imaging device 704 at a second position P2 relative to the target 710. As previously described, the methods may include determining a position and orientation of the imaging device 704 to generate a transformation matrix, and/or perform point cloud stitching for further generating a three-dimensional reconstruction and determining a physical dimension of the target 710.

To determine coordinates of the first and second positions of the imaging device 704, any point in the FOVs of the imaging device 704 may be used as an origin point. For example, a vertex of the target 710 may be used as the origin point 711 as illustrated in FIGS. 7A and 7B. It may be beneficial to use a physical feature of the target 710 that is closer to the imaging device 704 as a stronger signal may be received from that point in the FOV of the imaging device 704, but any point that is commonly visible in each of the perspective images may be used as the reference point or origin point. Taking the vertex 711 as the origin, the coordinates of the first position may be determined as (x₁, y₁, z₁) and the coordinates of the second position may be taken as (x₂, y₂, z₂). A transformation matrix may then be determined for translating the positions of the first point cloud obtained by the imaging device 704 at the first position P1, into a corresponding perspective of the image of the target taken at the second position P2, from the first and second coordinates. In examples, other coordinate systems may be used such as polar coordinates, angular coordinates, or another coordinate system for determining the first and second positions of the imaging device 704. For example, as illustrated in FIGS. 7A and 7B, angular coordinates (⊖ₓ₁, ⊖_{y1}, ⊖_{z1}) and (⊖ₓ₂, ⊖_{y2}, ⊖_{z2}) may be used for the respective first and second position coordinates for performing cloud stitching, determining the first and second positions of the imaging device 704, and/or performing cloud stitching. While illustrated at two positions in FIGS. 7A and 7B, it should be understood that the systems and methods described herein may be applied when obtaining a plurality of images from any number of positions relative to the target 710. In such matters, it should be understood that the coordinates of each camera position (xₙ, yₙ, zₙ) and/or (⊖ₓₙ, ⊖_{yn}, ⊖_{zn}) may be used with “n” being the number of the position (e.g., 1, 2, 3, 4, etc.). Additionally, coordinates indicative of the angular orientation of the imaging device 704, and/or a FOV of the imaging device 704 relative to the target 710 may be used to further determine a transformation matrix or perform cloud stitching.

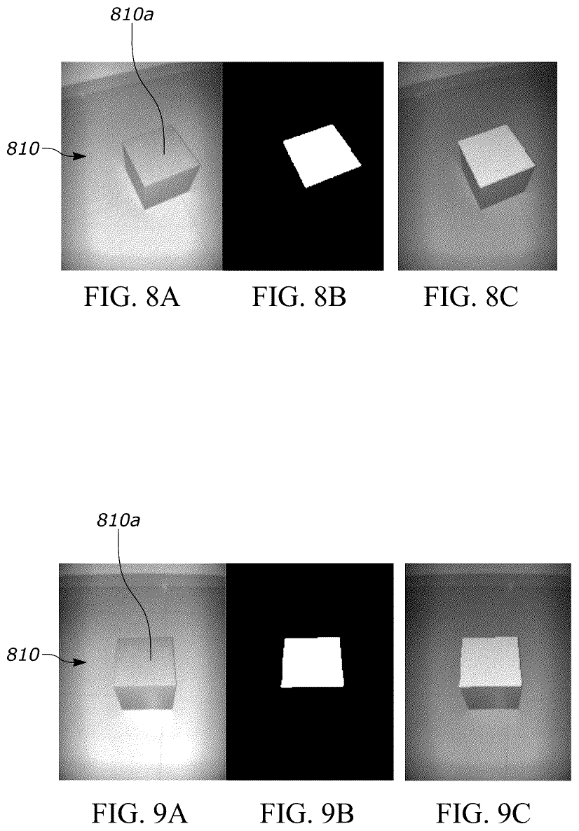

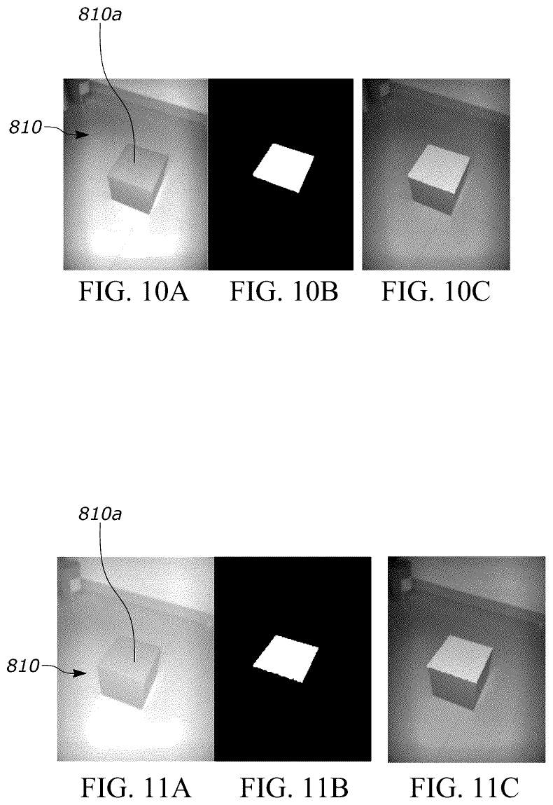

FIGS. 8A, 9A, 10A, and 11A are infrared images of a target 810 obtained by an imaging device at a first position, second position, third position, and fourth position respectively. Each of the perspectives of the imaging device includes a view of a top surface 810a of the target 810. In the described methods, the processor identifies the top surface 810a as a common physical feature among all of the images of FIGS. 8A, 9A, 10A, and 11A, and uses the top surface 810a as a reference feature for performing cloud stitching. FIGS. 8B, 9B, 10B, and 11B are image segmentations of the top surface 810a of the target 810. The segmentations are images of computer synthesized 3D surfaces based on the top surface 810a of the target 810. A 3D top plane surface is generated for each respective perspective provided in each of the images 8A, 9A, 10A, and 11A of the target 810. The orientation and position of the top surface 810a may then be determined between the images and the point clouds of the target may be merged based on the respective position and orientation of the top surface 810a in each image. FIGS. 8C, 9C, 10C, and 11C are combined images of the original IR image of the target 810 overlayed with the top plane segmentation of FIGS. 8B, 9B, 10B, and 11B. Each resulting overlay image may be used to correct for errors or noisy data in individual image frames with noise resulting from long distances from the imaging device to the target 810 or to distant parts of the target 810, multipaths, etc. The resulting combined images, and point clouds generated from the images of FIGS. 8C, 9C, 10C, and 11C are then further merged to further reduce and/or remove noisy point cloud data to produce a more accurate 3D representation of the target as described by the methods herein.

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions.

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

We claim:

1. A method for performing three dimensional imaging, the method comprising:
capturing, by an imaging system, a first image of a target in a first field of view of the imaging system;
capturing, by the imaging system, a second image of the target in a second field of view of the imaging system, the second field of view being different than the first field of view;
generating, by a processor, a first point cloud, corresponding to the target, from the first image;
generating, by the processor, a second point cloud, corresponding to the target, from the second image;
identifying, by the processor, a position and orientation of a reference feature of the target in the first image;
identifying, by the processor, a position and orientation of the reference feature in the second image;
performing, by the processor, point cloud stitching to combine the first point cloud and the second point cloud to form a merged point cloud, the point cloud stitching performed according to the orientation and position of the reference feature in each of the first point cloud and second point cloud;
identifying, by the processor, one or more noisy data points in the merged point cloud; and
removing, by the processor, at least one of the one or more noisy data points from the merged point cloud and generating an aggregated point cloud from the merged point cloud.

2. The method of claim 1, wherein performing point cloud stitching comprises:
identifying, by the processor, a position and orientation of a reference feature of the target in the first image;
identifying, by the processor, a position and orientation of the reference feature in the second image; and
performing, by the processor, the point cloud stitching according to the (I) identified position and orientation of the reference feature of the target in the first image and (ii) position and orientation of a reference feature of the target in the second image.

3. The method of claim 1, wherein the reference feature comprises one of a surface, a vertex, a corner, and one or more line edges.

4. The method of claim 1, further comprising:
determining, by the processor, a first position of the imaging system from the position and orientation of the reference feature in the first point cloud;
determining, by the processor, a second position of the imaging system from the position and orientation of the reference feature in the second point cloud; and
performing, by the processor, the point cloud stitching further according to the determined first position of the imaging system and second position of the imaging system.

5. The method of claim 1, further comprising determining, by the processor, a transformation matrix from the position and orientation of the reference feature in the first point cloud and position and orientation of the reference feature in the second point cloud.

6. The method of claim 1, wherein identifying one or more noisy data points comprises:
determining, by the processor, voxels in the merged point cloud;
determining, by the processor, a number of data points of the merged point cloud in each voxel;
identifying, by the processor, voxels containing a number of data points less than a threshold value; and
identifying, by the processor, the noisy data points as data points in voxels containing equal to or less than the threshold value of data points.

7. The method of claim 6, wherein the threshold value is dependent on one or more of an image frame count, image resolution, and voxel size.

8. The method of claim 1, further comprising:
performing, by the processor, a three-dimensional construction of the target from the aggregated point cloud; and
determining, by the processor and from the three-dimensional construction, a physical dimension of the target.

9. The method of claim 1, wherein the first field of view provides a first perspective of the target, and the second field of view provides a second perspective of the target, the second perspective of the target being different than the first perspective of the target.

10. The method of claim 1, further comprising performing z-buffering on at least one of the first point cloud, second point cloud, or merged point cloud to exclude data points outside of the first field of view or second field of view of the imaging system.

11. The method of claim 1, wherein the imaging system comprises an infrared camera, a color camera, two-dimensional camera, a three-dimensional camera, a handheld camera, or a plurality of cameras.

12. An imaging system for performing three dimensional imaging, the system comprising:
one or more imaging devices configured to capture images;
one or more processors configured to receive data from the one or more imaging devices; and
one or more non-transitory memories storing computer-executable instructions that, when executed via the one or more processors, cause the imaging system to:
capture, by the one or more imaging devices, a first image of a target in a first field of view of the imaging system;
capture, by the one or more imaging devices, a second image of the target in a second field of view of the imaging system, the second field of view being different than the first field of view;
generate, by the processor, a first point cloud, corresponding to the target, from the first image;
generate, by the processor, a second point cloud, corresponding to the target, from the second image;
identify, by the processor, a position and orientation of a reference feature of the target in the first image;
identify, by the processor, a position and orientation of the reference feature in the second image;
perform, by the processor, point cloud stitching to combine the first point cloud and the second point cloud to form a merged point cloud, the point cloud stitching performed according to the orientation and position of the reference feature in each of the first point cloud and second point cloud;
identify, by the processor, one or more noisy data points in the merged point cloud; and
remove, by the processor, at least one of the one or more noisy data points from the merged point cloud and generating an aggregated point cloud from the merged point cloud.

13. The imaging system of claim 12, wherein the computer-executable instructions further cause the imaging system to:
identify, by the processor, a position and orientation of a reference feature of the target in the first image;
identify, by the processor, a position and orientation of the reference feature in the second image; and
perform, by the processor, the point cloud stitching according to the (i) identified position and orientation of the reference feature of the target in the first image and (ii) position and orientation of a reference feature of the target in the second image.

14. The imaging system of claim 12, wherein the computer-executable instructions further cause the imaging system to:
determine, by the processor, a first position of the imaging device at the first field of view of the imaging system, from the position and orientation of the reference feature in the first point cloud;
determine, by the processor, a second position of the imaging device at the second field of view of the imaging system, from the position and orientation of the reference feature in the second point cloud; and
perform, by the processor, the point cloud stitching further according to the determined first position of the imaging device at the first field of view of the imaging system and second position of the imaging device at the second field of view of the imaging system.

15. The imaging system of claim 12, wherein the computer-executable instructions further cause the imaging system to:
determine, by the processor, voxels in the merged point cloud;
determine, by the processor, a number of data points of the merged point cloud in each voxel;
identify, by the processor, voxels containing a number of data points less than a threshold value; and
identify, by the processor, the noisy data points as data points in voxels containing equal to or less than the threshold value of data points.

16. The imaging system of claim 12, wherein the first field of view provides a first perspective of the target, and the second field of view provides a second perspective of the target, the second perspective of the target being different than the first perspective of the target.

17. One or more non-transitory computer-readable media storing computer-executable instructions that, when executed via one or more processors, cause one or more imaging systems to:
capture, by one or more imaging devices, a first image of a target in a first field of view of the imaging system;
capture, by the one or more imaging devices, a second image of the target in a second field of view of the imaging system, the second field of view being different than the first field of view;
generate, by a processor, a first point cloud, corresponding to the target, from the first image;
generate, by the processor, a second point cloud, corresponding to the target, from the second image;
identify, by the processor, a position and orientation of a reference feature of the target in the first image;
identifying, by the processor, a position and orientation of the reference feature in the second image;
perform, by the processor, point cloud stitching to combine the first point cloud and the second point cloud to form a merged point cloud, the point cloud stitching performed according to the orientation and position of the reference feature in each of the first point cloud and second point cloud;
identify, by the processor, one or more noisy data points in the merged point cloud; and
remove, by the processor, at least one of the one or more noisy data points from the merged point cloud and generating an aggregated point cloud from the merged point cloud.

18. The one or more non-transitory computer-readable media of claim 17, wherein the computer-executable instructions further cause the imaging system to:
identify, by the processor, a position and orientation of a reference feature of the target in the first image;
identify, by the processor, a position and orientation of the reference feature in the second image; and
perform, by the processor, the point cloud stitching according to the (i) identified position and orientation of the reference feature of the target in the first image and (ii) position and orientation of a reference feature of the target in the second image.

19. The one or more non-transitory computer-readable media of claim 17, wherein the computer-executable instructions further cause the imaging system to:
determine, by the processor, a first position of the imaging device at the first field of view of the imaging system, from the position and orientation of the reference feature in the first point cloud;
determine, by the processor, a second position of the imaging device at the second field of view of the imaging system, from the position and orientation of the reference feature in the second point cloud; and
perform, by the processor, the point cloud stitching further according to the determined first position of the imaging device at the first field of view of the imaging system and second position of the imaging device at the second field of view of the imaging system.

20. The one or more non-transitory computer-readable media of claim 17, wherein the computer-executable instructions further cause the imaging system to:
determine, by the processor, voxels in the merged point cloud;
determine, by the processor, a number of data points of the merged point cloud in each voxel;
identify, by the processor, voxels containing a number of data points less than a threshold value; and
identify, by the processor, the noisy data points as data points in voxels containing equal to or less than the threshold value of data points.
